(19) United States
(12) Patent Application Publication
(10) Pub. No.: US 2008/0036701 A1
(43) Pub. Date: Feb. 14, 2008

(54) Method of driving electrodes in a plasma display device

(76) Inventor: Jae-Young Yeo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/878,746

(22) Filed: Jul. 26, 2007

(30) Foreign Application Priority Data
Aug. 10, 2006 (KR) 10-2006-0075834
Aug. 30, 2006 (KR) 10-2006-0082933

(51) Int. Cl. G09G 3/28

(52) U.S. Cl. 345/60

(57) ABSTRACT

A method of driving electrodes in a plasma display device, which includes a plurality of first electrodes and a plurality of second electrodes for performing a reset and a display period, includes classifying a plurality of first drive signals, applied to the plurality of first electrodes, into a plurality of groups, and increasing the voltage of the plurality of groups of first drive signals from a first voltage to a second voltage during the reset period, the increase of the voltage of the plurality of groups of first electrodes having a predetermined time interval therebetween.

### BACKGROUND OF THE INVENTION

1. Field of the Invention

Embodiments relate to a plasma display device displaying an image, and more particularly, to a method of operating a plurality of electrodes in the plasma display device.

2. Description of the Related Art

A plasma display device is a flat display device that displays an image using a plasma discharge. A conventional plasma display device includes a plasma display panel (PDP) and a plurality of electrode driving units. The PDP may include a plurality of address electrodes, a plurality of scan electrodes, and a plurality of sustain electrodes. The plurality of electrode driving units may include an address electrode driving unit, which drives the plurality of address electrodes, a scan electrode driving unit, which drives the plurality of scan electrodes, and a sustain electrode driving unit, which drives the plurality of sustain electrodes.

Conventionally, a scan signal is applied to the plurality of scan electrodes, and simultaneously, address signals are applied to the plurality of address electrodes. The scan signal and the address signals may be used to perform a reset period, an address period, and a sustain period at each subfield in order to display gray scale of the image on the PDP.

Typically, in the reset period, identical signals are simultaneously applied from an electrode driving unit to the plurality of scan electrodes and/or the plurality of address electrodes to remove wall charges previously formed. However, when these signals reach a certain magnitude, a very high peak current may flow through an output terminal of the electrode to which the signal is supplied to the driving unit supplying the signal in a short period of time. Thus, electro-magnetic interference may occur in an internal circuit of the electrode driving unit, which may result in the electrode driving unit malfunctioning. Accordingly, an accurate image may not be displayed on a screen of the PDP.

### SUMMARY OF THE INVENTION

Embodiments are therefore directed to a method of driving electrodes in a plasma display device that substantially overcomes one or more of the problems due to the limitations and disadvantages of the related art.

It is therefore a feature of an embodiment of the present invention to provide a method of driving electrodes which reduces or prevents electro-magnetic interference while driving a plurality of the electrodes.

At least one of the above and other features and advantages may be realized by providing a method of driving electrodes in a plasma display device, which includes a plurality of first electrodes and a plurality of second electrodes for performing a reset and a display period, the method including classifying a plurality of first drive signals, applied to the plurality of first electrodes, into a plurality of groups, and increasing the voltage of the plurality of groups of first drive signals from a first voltage to a second voltage during the reset period, the increase of the voltage of the plurality of groups of first electrodes having a predetermined time interval therebetween.

Simultaneous with the increasing the voltage of the plurality of groups of first drive signals, the voltage of a second drive signal, applied to the plurality of second electrodes, may be increased from a ground voltage to a positive voltage higher than the ground voltage. The voltage of the second drive signal may be rapidly increased from the ground voltage to the positive voltage, and during this time, the voltage of groups of the first drive signals is increased having a predetermined time interval therebetween. The voltage of the second drive signal may be rapidly increased from the ground voltage to the positive voltage, and then slowly increased from the positive voltage to a higher positive voltage during the reset period.

The first voltage may be a ground voltage, the second voltage may be a positive voltage, and the voltage of the second drive signal may be decreased from the positive voltage to a negative voltage lower than the ground voltage during the reset period.

During the reset period, a negative pulse decreasing from a ground voltage to a third voltage and increasing from the third voltage to a fourth voltage may be applied to the first electrodes. The positive pulse may rapidly increase from the ground voltage to the first voltage. The first voltage may be the ground voltage, the second voltage may be a positive voltage, the third voltage may be a negative voltage lower than the ground voltage, the fourth voltage may be a negative voltage lower than a ground voltage and higher than the third voltage, and scan pulses may be sequentially applied to the first electrodes during the display period.

The first electrodes may be address electrodes and the second electrodes may be scan electrodes. Alternatively, the first electrodes may be scan electrodes and the second electrodes may be address electrodes.

At least one of the above and other features and advantages may be realized by providing a method of driving electrodes in a plasma display device including a plurality of scan electrodes and a plurality of address electrodes for performing a reset period and a display period, the method including increasing a voltage of a scan signal applied to the plurality of scan electrodes from a ground voltage to a positive voltage higher than the ground voltage, and simultaneously floating a plurality of address signals applied to the plurality of address electrodes for a predetermined time during the reset period.

The plurality of address signals may be floated while the voltage of the scan signal increases from the ground voltage to the positive voltage. The voltage of the scan signal may be rapidly increased from the ground voltage to the positive voltage and then slowly increased to a higher positive voltage during the reset period. The voltage of the scan signal may be decreased from the positive voltage to a negative voltage lower than the ground voltage during the reset period.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a plasma display device according to an embodiment;

FIG. 2 illustrates an exploded perspective view of a plasma display panel of FIG. 1;

FIG. 3 illustrates a block diagram of an address electrode driving unit of FIG. 1 according to an embodiment;

FIG. 4 illustrates a circuit diagram of one of a plurality of output units of FIG. 3;

FIG. 5 illustrates a timing diagram of signals and size of a current in order to describe a method of driving electrodes according to an embodiment;

FIG. 6 illustrates a timing diagram of signals and size of a current when address signals illustrated in FIG. 5 are classified into three groups;

FIG. 7 illustrates a waveform diagram of signals and size of a current in order to describe a method of driving electrodes according to an embodiment;

FIG. 8 illustrates size of a voltage induced to address electrodes illustrated in FIG. 2 by address signals of FIG. 7;

FIG. 9 illustrates a waveform diagram of signals and size of a current in order to describe a method of driving electrodes according to another embodiment of the present invention;

FIG. 10 illustrates a block diagram of a scan electrode driving unit illustrated in FIG. 1 according to an embodiment;

FIG. 11 illustrates a first and second power supply voltage control units of FIG. 12, and one circuit diagram from among a plurality output units connected to the first and second power supply voltage control units;

FIG. 12 illustrates a timing diagram of scan signals illustrated in FIG. 10, and peak values of a current flowing through an output terminal of a scan electrode driving unit illustrated in FIG. 1 at certain points of time;

FIG. 13 illustrates a block diagram of a scan electrode driving unit of FIG. 1 according to an embodiment; and

FIG. 14 illustrates a timing diagram of scan signals of FIG. 13 and size of a current flowing through an output terminal of a scan electrode driving unit of FIG. 1 at certain points of time.

### DETAILED DESCRIPTION OF THE INVENTION

Korean Patent Application Nos. 10-2006-0075834, filed on Aug. 10, 2006, and 10-2006-0082933, filed on Aug. 30, 2006 in the Korean Intellectual Property Office, and entitled: “Method of Driving Electrodes in Plasma Display Device,” are incorporated by reference herein in their entirety.

Hereinafter, embodiments of the present invention will be described more fully with reference to the accompanying drawings, in which exemplary embodiments are shown. In the drawings, like reference numerals denote like elements.

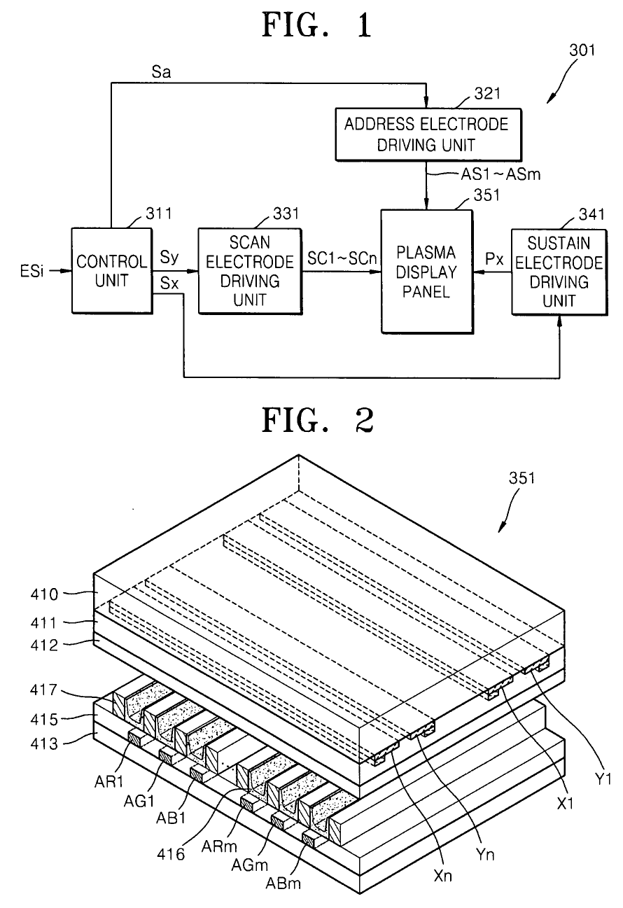

FIG. 1 illustrates a block diagram of a plasma display device 301 according to an embodiment. Referring to FIG. 1, the plasma display device 301 may include a control unit 311, an address electrode driving unit 321, a scan electrode driving unit 331, a sustain electrode driving unit 341, and a plasma display panel (PDP) 351.

The control unit 311 may receive an external image signal ESi, and may output address data Sa, a scan control signal Sy and a sustain control signal Sx in order to control operations of the address electrode driving unit 321, the scan electrode driving unit 331, and the sustain electrode driving unit 341.

FIG. 2 illustrates an exploded perspective view of the PDP 351 of FIG. 1. Referring to FIG. 2, the PDP 351 may include address electrodes AR1 through ARm, AG1 through AGm, and AB1 through ABm, scan electrodes Y1 through Yn, sustain electrodes X1 through Xn, dielectric layers 411 and 415, phosphor layers 416, barrier ribs 417, and a protective layer 412 between a front substrate 410 and a rear substrate 413.

The sustain electrodes X1 through Xn and the scan electrodes Y1 through Yn may be disposed in a predetermined pattern in order to cross the address electrodes AR1 through ARm, AG1 through AGm, and AB1 through ABm. Discharge cells may be formed at each cross point. The discharge cells may be partitioned by the barrier ribs 417. Plasma gas may be sealed inside the discharge cells.

Referring FIGS. 1 and 2, the address electrode driving unit 321 may output address signals AS1 through ASm to address electrodes AR1 through ARm, AG1 through AGm, and AB1 through ABm, in response to the address data Sa received from the control unit 311. The address data Sa may include red data addressing red address electrodes AR1 through ARm of FIG. 2, green data addressing green address electrodes AG1 through AGm of FIG. 2, and blue data addressing blue address electrodes AB1 through ABm of FIG. 2.

The scan electrode driving unit 331 may output scan signals SC1 through SCn for driving scan electrodes Y1 through Yn illustrated in FIG. 2 in response to the scan control signal Sy received from the control unit 311. When the scan signals SC1 through SCn are applied to the scan electrodes Y1 through Yn of FIG. 2, the address signals AS1 through ASm may also be applied to the address electrodes AR1 through ARm, AG1 through AGm, and AB1 through ABm of FIG. 2. A discharge is generated in discharge cells receiving both scan signals SC1 through SCn and address signals AS1 through ASm.

The sustain electrode driving unit 341 may drive sustain electrodes X1 through Xn illustrated in FIG. 2 by outputting a sustain signal Px in response to the sustain control signal Sx received from the control unit 311. The sustain signal Px may be applied only to the addressed discharge cells in order to maintain an address discharge already generated.

The PDP 351 may receive the address signals AS1 through ASm, the scan signals SC1 through SCn, and the sustain signal Px, respectively output from the address electrode driving unit 321, the scan electrode driving unit 331, and the sustain electrode driving unit 341, in order to visually display an image on a screen.

The present invention may be applied in a plasma display device having a plurality of electrodes, including two or four types of electrodes, in addition to the plasma display panel 301 having the three types of electrodes as described with reference to FIGS. 1 and 2.

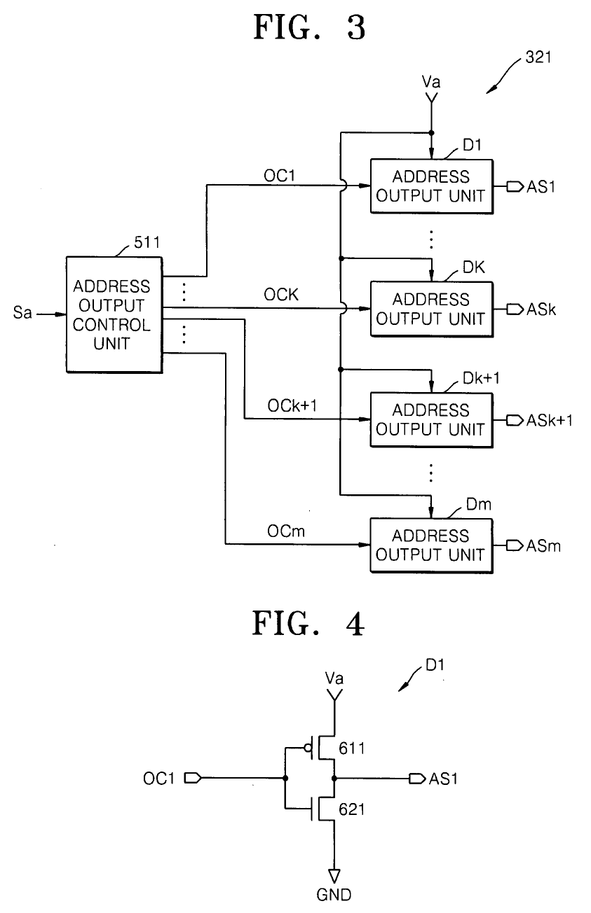

FIG. 3 illustrates a block diagram of the address electrode driving unit 321 of FIG. 1 according to an embodiment. Referring to FIG. 3, the address electrode driving unit 321 may include an address output control unit 511 and a plurality of address output units D1 through Dm.

The address output control unit 511 may be connected to the plurality of address output control units D1 through Dm. The address output control unit 511 may receive the address data Sa output from the control unit 311 of FIG. 1, and may output a plurality of output control signals OC1 through OCm. The address output control unit 511 may output the plurality of output control signals OC1 through OCm in logic high or logic low based on content of the address data Sa.

The plurality of address output units D1 through Dm may each be connected to each of the plurality of address electrodes AR1 through ARm, AG1 through AGm, and AB1 through ABm of FIG. 2. The plurality of address output units D1 through Dm may operate address electrodes AR1 through ARm, AG1 through AGm, and AB1 through ABm of FIG. 4 by outputting either the address voltage Va or the ground voltage GND, in response to the output control signals OC1 through OCm output from the address output control unit 511.

The plurality of address output units D1 through Dm may be classified into two groups of address output units D1 through Dk and Dk+1 through Dm. That is, the plurality of address output units D1 through Dm may be classified into a first plurality of address output units D1 through Dk and a second plurality of address output units Dk+1 through Dm. The first plurality of address output units D1 through Dk may be connected to a first half of the plurality of address electrodes AR1 through ARm, AG1 through AGm, and AB1 through ABm of FIG. 2, and the second plurality of address output units Dk+1 through Dm may be connected to a second half of the plurality of address electrodes AR1 through ARm, AG1 through AGm, and AB1 through ABm of FIG. 2.

The first plurality of address output units D1 through Dk may operate in response to the output control signals OC1 through OCk. For example, when the output control signals OC1 through OCk are logic high, the first plurality of address output units D1 through Dk may output the ground voltage GND in order to apply the ground voltage GND to the first half of the address electrodes AR1 through ARm, AG1 through AGm, and AB1 through ABm of FIG. 2, and, when the output control signals OC1 through OCk are logic low, the first plurality of address output units D1 through Dk may output the address voltage Va in order to apply the address voltage Va to the second half of the address electrodes AR1 through ARm, AG1 through AGm, and AB1 through ABm of FIG. 2.

The second plurality of address output units Dk+1 through Dm may operate in response to the output control signals OCk+1 through OCm. For example, when the output control signals OCk+1 through OCm are logic high, the second plurality of address output units Dk+1 through Dm may output the ground voltage GND in order to apply the ground voltage GND to the second half of the address electrodes AR1 through ARm, AG1 through AGm, and AB1 through ABm of FIG. 2, and when the output control signals OCk+1 through OCm are logic low, the second plurality of address output units Dk+1 through Dm may output the address voltage Va in order to apply the address voltage Va to the remaining half of the address electrodes AR1 through ARm, AG1 through AGm, and AB1 through ABm of FIG. 2.

The plurality of address output units D1 through Dm may be formed of, e.g., a plurality of integrated circuit devices or a plurality of tape carrier packages.

FIG. 4 illustrates a circuit diagram of one of the output units from among the plurality of output units D1 through Dm of FIG. 3.

Referring to FIG. 4, the address output unit D1 may include a PMOS transistor 611 and an NMOS transistor 621. The output control signal OC1, output from the output control unit 511 of FIG. 3, may be applied to gates of the PMOS transistor 611 and the NMOS transistor 621. Accordingly, when the output control signal OC1 is logic low, the PMOS transistor 611 is activated, and thus the address output unit D1 outputs the address voltage Va as the address signal AS1. When the output control signal OC1 is logic high, the NMOS transistor 621 is activated, and thus the address output unit D1 outputs the ground voltage GND as the address signal AS1.

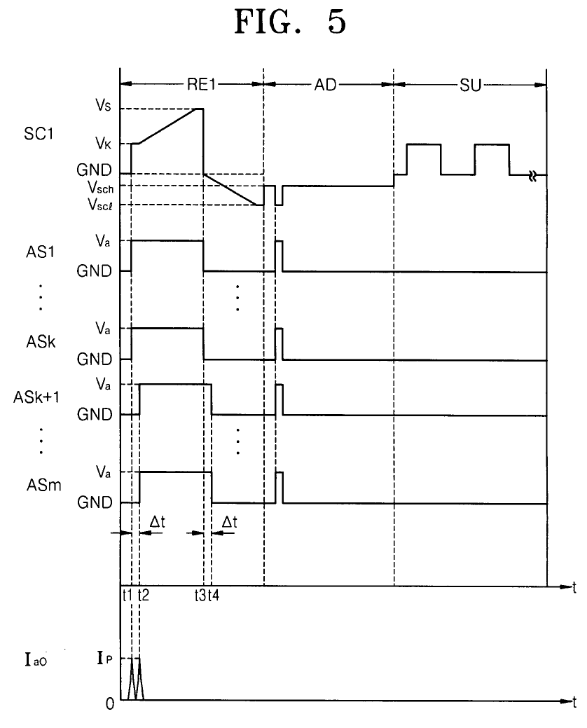

FIG. 5 illustrates a timing diagram of signals SC1 and AS1 through ASm, and size of a current Iao flowing through an output terminal of the address electrode driving unit 321 in order to describe a method of driving electrodes according to an embodiment.

In order to display an image on the PDP 351 of FIG. 1, a plurality of scan signals including a scan signal SC1, output from the scan electrode driving unit 311 of FIG. 1, may be applied to the plurality of scan electrodes Y1 through Yn of FIG. 4, and a plurality of address signals AS1 through ASm, output from the address electrode driving unit, may be applied to the plurality of address electrodes AR1 through ARm, AG1 through AGm, and AB1 through ABm of FIG. 2. At this time, the plurality of address signals AS1 through ASm may be classified into two groups of address signals AS1 through ASk and ASk+1 through ASm. That is, the plurality of address signals AS1 through ASm may be classified into a first plurality of address signals AS1 through ASk and a second plurality of address signals ASk+1 through ASm. A reset period RE1, an address period AD, and a sustain period SU may be performed to display gray scale of an image.

During the reset period RE1, the plurality of scan signals SC1 through SC, and the plurality of address signals AS1 through ASm may be applied to the scan electrodes Y1 through Yn of FIG. 2 and the address electrodes AR1 through ARm, AG1 through AGm, and AB1 through ABm of FIG. 2 in order to remove wall charges formerly formed therein. The scan signals SC1 through SCn may include a ramp waveform. The scan signals SC1 through SCn may rapidly increase from a ground voltage GND to a positive voltage Vk, higher than the ground voltage GND, and then slowly increase to a voltage Vs, higher than the positive voltage Vk.

While the plurality of scan signals SC1 through SCn rapidly increase from the ground voltage GND to the positive voltage Vk, the first plurality of address signals AS1 through ASk are increased from a first voltage GND to a second voltage Va, and after a predetermined time interval Δt, the second plurality of address signals ASk+1 through ASm are increased from the first voltage GND to the second voltage Va. Here, the first voltage is the ground voltage GND, and the second voltage is the address voltage Va, which is a positive voltage higher than the ground voltage GND.

In the address period AD, the scan pulses of the scan signals SC1 through SCn may be sequentially applied to the scan electrodes Y1 through Yn of FIG. 2. Whenever the scan signals SC1 through SCn are applied to the scan electrodes Y1 through Yn of FIG. 2, the plurality of address signals AS1 through ASm are applied to the plurality of address electrodes AR1 through ARm, AG1 through AGm, and AB1 through ABm of FIG. 2. Accordingly, discharge cells are addressed, and an address discharge is generated in the addressed discharge cells.

In the sustain period SU, sustain pulses, output from the sustain electrode unit, may be applied to the plurality of scan electrodes Y1 through Yn of FIG. 2 in order to sustain the discharge generated in the addressed discharge cells.

As described above, in the initial reset period RE1, the first plurality of address signals AS1 through ASk and the second plurality of address signals ASk+1 through ASm are respectively applied to the address electrodes AR1 through ARm, AG1 through AGm, and AB1 through ABm of FIG. 2 within a predetermined time interval Δt. That is, at a first point of time t1 of the reset period RE1, when the voltage of the scan signal SC1 rapidly increases from the ground voltage GND to the positive voltage Vk, higher than the ground voltage GND, the first plurality of address signals AS1 through ASk increase from the first voltage GND to the second voltage Va. At a second point of time t2, after the predetermined time interval Δt, the second plurality of address signals ASk+1 through ASm increases from the ground voltage GND to the second voltage Va.

Accordingly, by classifying the address signals AS1 through ASm into two groups in the reset period RE1 and successively applying the two groups of address signals AS1 through ASk and ASk+1 through ASm at the certain points of time t1 and t2, having the predetermined time interval Δt therebetween, to the address electrodes AR1 through ARm, AG1 through AGm, and AB1 through ABm, peak values Ip of a current Iao flowing through an output terminal of the address electrode driving unit 321 of FIG. 3 at the certain points of time t1 and t2 may be half a peak value in a conventional method, in which the address signals AS1 through ASm are simultaneously applied to the address electrodes AR1 through ARm, AG1 through AGm, and AB1 through ABm of FIG. 2. Accordingly, an electro-magnetic interference inside the address electrode driving unit 321 of FIG. 1 may be reduced or prevented.

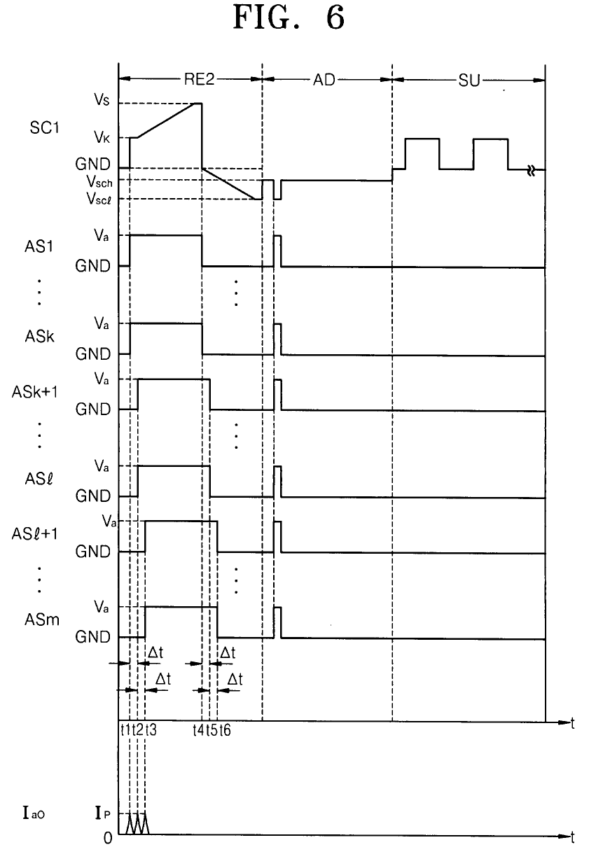

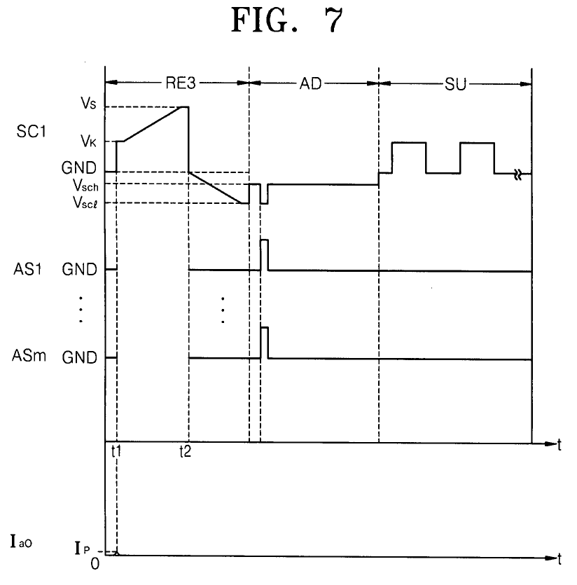

FIG. 6 illustrates a timing diagram of signals SC1 and AS1 through ASm and size of a current Iao when address signals AS1 through ASm illustrated in FIG. 5 are classified into three groups.

Referring to FIG. 6, the address signals AS1 through ASm may be classified into three groups, i.e. a first plurality of address signals AS1 through ASk, a second plurality of address signals ASk+1 through ASl, and a third plurality of address signals ASl+1 through ASm.

Then, during an initial reset period RE2, the first plurality of address signals AS1 through ASk, the second plurality of address signals ASk+1 through AS1, and the third plurality of address signals ASl+1 through ASm are successively applied to the address electrodes AR1 through ARm, AG1 through AGm, and AB1 through ABm, with a mutual predetermined time interval Δt. That is, at a first point of time t1 of the reset period RE2, when the plurality of scan signals SC1 rapidly increases from the ground voltage GND to the higher positive voltage Vk, higher than the ground voltage GND, the first plurality of address signals AS1 through ASk increases from the first voltage GND to the second voltage Va, at a second point of time t2 after the predetermined time interval Δt, the second plurality of address signals ASk+1 through ASl increases from the first voltage GND to the second voltage Va, and at a third point of time t3 after the predetermined time interval Δt, the third plurality of address signals ASl+1 through ASm increases from the first voltage GND to the second voltage Va.

As described above, by classifying the address signals AS1 through ASm into three groups in the reset period RE2, and applying the three groups of address signals AS1 through ASk, ASk+1 through ASl, and ASl+1 through ASm at the predetermined points of time t1, t2, and t3 after the predetermined time interval Δt, to the address electrodes AR1 through ARm, AG1 through AGm, and AB1 through ABm of FIG. 2, peak values Ip of a current Iao flowing through an output terminal of the address electrode driving unit 321 of FIG. 3 at the predetermined points of time t1, t2, and t3 may be lower than when the address signals AS1 through ASm are classified into two groups. Accordingly, an electro-magnetic interference inside the address electrode driving unit 321 of FIG. 1 may be reduced or prevented.

FIG. 7 illustrates a waveform diagram of signals SC1 and AS1 through ASm and size of a current Iao in order to describe a method of driving electrodes according to another embodiment of the present invention.

Referring to FIG. 7, in a reset period RE3, during the time t1 through t2 the scan signal SC1 may increase from a ground voltage GND to a positive voltage Vs higher than the ground voltage GND, and the address signals AS1 through ASm may be floated. In order to float the address signals AS1 through ASm, output terminals of the plurality of address output units D1 through Dm of FIG. 3 may be in a high impedance state.

Referring back to FIG. 4, when the output control signal OC1 is logic high, the NMOS transistor 621 is activated and thus, the address signal AS1 decreases to the ground voltage GND, and when the output control signal OC1 is logic low, the PMOS transistor 611 is activated and thus, the address signal AS1 increases to the address voltage Va. Accordingly, in order to float the address signal AS1, the output control signal OC1 should be in the middle of logic high and logic low. For example, when logic high of the output control signal OC1 is 1.2 volts and logic low of the output control signal OC1 is 0.4 volts, the middle of logic high and logic low is 0.8 volts. Then, the PMOS transistor 611 and the NMOS transistor 621 are both deactivated and thus, the output terminal of the address output unit D1 is in the high impedance state. Accordingly, the address signal AS1 is floated.

As described, by floating the address signals AS1 through ASm while the scan signal SC1 increases from the ground voltage GND to the positive voltage Vs in the reset period RE3, the current Iao flowing through the output terminal of the address electrode driving unit 321 of FIG. 1 may be very low.

Accordingly, while the address electrodes AR1 through ARm, AG1 through AGm, and AB1 through ABm of FIG. 2 operate, an electro-magnetic interference does not occur in an internal circuit of the address electrode driving unit 321 of FIG. 1.

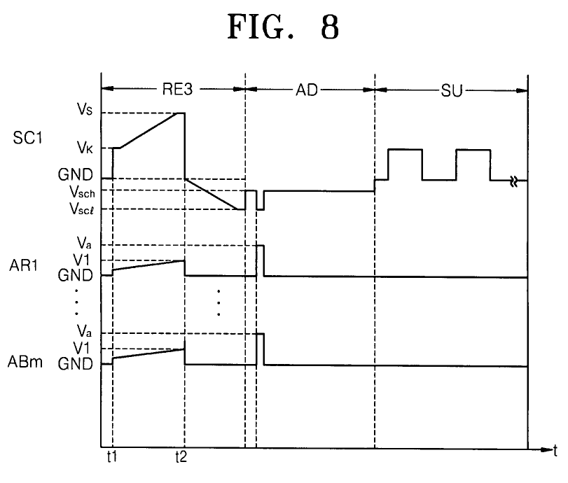

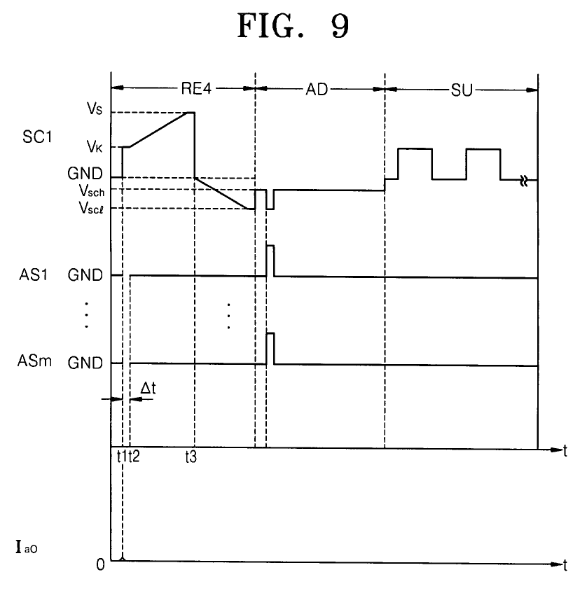

FIG. 8 illustrates a diagram of a size of a voltage induced in address electrodes AR1 through ARm, AG1 through AGm, and AB1 through ABm of FIG. 4 by address signals AS1 through ASm illustrated in FIG. 7.

Referring to FIG. 8, in the reset period RE3, when the address signals AS1 through ASm are floated between the times t1 through t2, the scan signal SC1 increases from the ground voltage GND to the higher voltage Vs higher than the ground voltage, a voltage V1 lower than the address voltage Va is applied to the address electrodes AR1 through ARm, AG1 through AGm, and AB1 through ABm of FIG. 4 by the scan signals including a scan signal SC1 applied to the scan electrodes Y1 through Yn of FIG. 2.

Accordingly, accumulation of positive wall charges is prevented near the address electrodes AR1 through ARm, AG1 through AGm, and AB1 through ABm of FIG. 4, and thus an address discharge may be generated smoothly. That is, the effect is equal to when a predetermined voltage V1 is applied to the address electrodes AR1 through ARm, AG1 through AGm, and AB1 through ABm of FIG. 2.

FIG. 9 illustrates a waveform diagram of signals SC1 and AS1 through ASm and size of a current Iao in order to describe a method of driving electrodes according to another embodiment of the present invention.

Referring to FIG. 9, in the initial portion of a reset period RE4, when the voltage of the scan signal SC1 rapidly increases from the ground voltage GND to the positive voltage Vk higher than the ground voltage GND, the address signals AS1 through ASm may be floated for a predetermined time t1 through t2. A method of floating the address signals AS1 through ASm is as described above with reference to FIG. 7.

Accordingly, by rapidly increasing the voltage of the scan signal SC1 from the ground voltage GND to the positive voltage Vk during the initial reset period RE4 and floating the address signals AS1 through ASm for the predetermined time t1 through t2, the current Iao flowing through an output terminal of the address electrode driving unit 321 of FIG. 1 may be very low.

Thus, an electro-magnetic interference in internal circuits of the address electrode driving unit 321 of FIG. 1 may be reduced or prevented while operating the address electrodes AR1 through ARm, AG1 through AGm, and AB1 through ABm of FIG. 2.

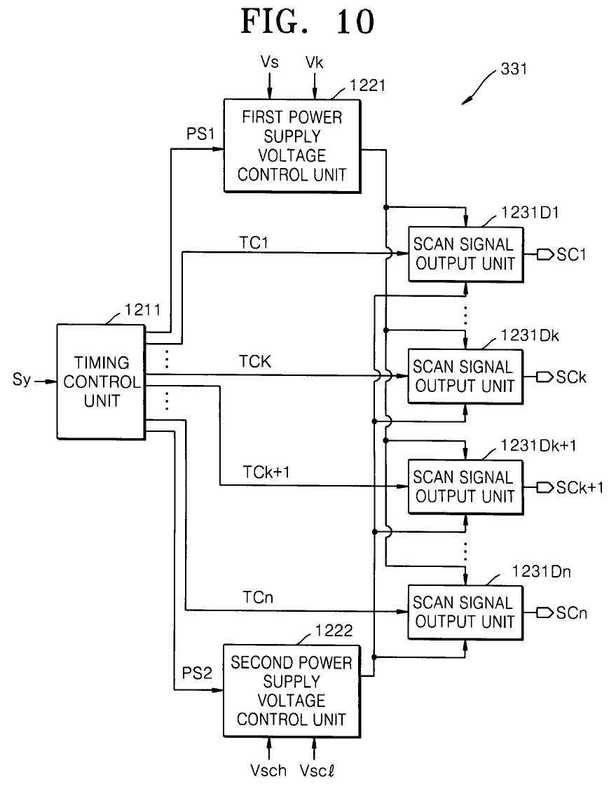

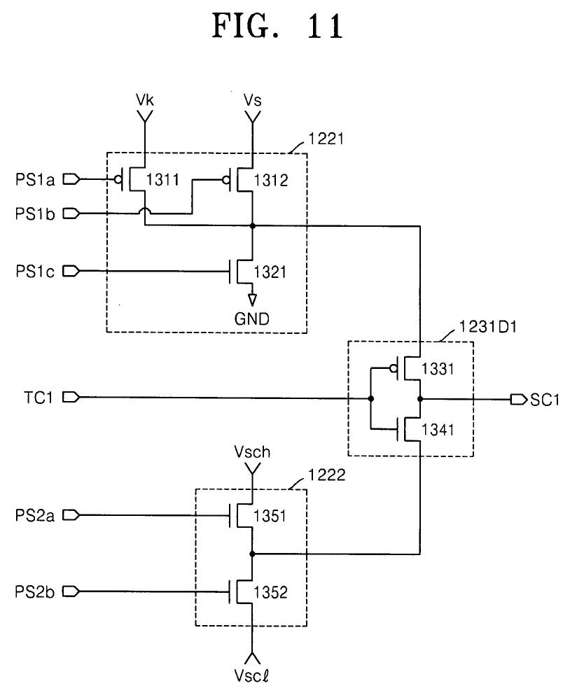

FIG. 10 illustrates a block diagram of the scan electrode driving unit 331 of FIG. 3 according to an embodiment. Referring to FIG. 10, the scan electrode driving unit 331 may include a timing control unit 1211, first and second power supply voltage control units 1221 and 1222, and a plurality of scan signal output units 1231D1 through 1231Dk and 1231Dk+1 through 1231Dn.

The timing control unit 1211 may be connected to the plurality of scan signal output units 1231D1 through 1231Dn. The timing control unit 1211 may receive a scan control signal Sy, output from the control unit 311 of FIG. 3, and may output a plurality of voltage control signals PS1 to PS2, and a plurality of timing control signals TC1 through TCn. The timing control unit 121 may be activated when the scan control signal Sy is activated, and may output and transmit the plurality of voltage control signals PS1 to PS2 and the plurality of timing control signals TC1 through TCn to the plurality of scan signal output units 1231D1 through 1231Dn.

The first power supply voltage control unit 1221 may be connected to the plurality of scan signal output units 1231D1 through 1231Dn. The first power supply voltage control unit 1221 may receive a plurality of power supply voltages Vs and Vk, output from a power supply unit (not shown), and may output any one of the plurality of power supply voltages Vs and Vk to the plurality of scan signal output units 1231D1 through 1231Dn, in response to the voltage control signal PS1.

The second power supply voltage control unit 1222 may be connected to the plurality of scan signal output units 1231D1 through 1231Dn. The second power supply voltage control unit 1222 may receive a plurality of power supply voltages Vsch and Vscl, output from a power source, and may output any one of the plurality of power supply voltages Vsch and Vscl to the plurality of scan signal output units 1231D1 through 1231Dn, in response to the voltage control signal PS2.

The plurality of scan signal output units 1231D1 through 1231Dn may be connected to a corresponding scan electrode of the plurality of scan electrodes Y1 through Yn of FIG. 2. The plurality of scan signal output units 1231Dn through 1231Dn may operate the scan electrodes Y1 through Yn of FIG. 2 by receiving any one of voltages Vs, Vk, Vsch, Vscl, and GND, transmitted from the first and second power supply voltage control units 1221 and 1222, in response to the timing control signals TC1 through TCn, output from the timing control unit 1211.

The plurality of scan signal output units 1231D1 through 1231Dn may be classified into two groups of scan signal output units 1231D1 through 1231Dk and 1231Dk+1 through 1231Dn. That is, the plurality of scan signal output units 1231D1 through 1231Dn may be classified into a first plurality of scan signal output units 1231D1 through 1231Dk and a second plurality of scan signal output units 1231Dk+1 through 1231Dn. The first plurality of scan signal output units 1231D1 through 1231Dk may be connected to a first half of the plurality of scan electrodes Y1 through Yn of FIG. 2 and the second plurality of scan signal output units 1231Dk+1 through Dn may be connected to a second half of the plurality of scan electrodes Y1 through Yn.

The first plurality of scan signal output units 1231D1 through 1231Dk may operate in response to the timing control signals TC1 through TCk. For example, when the timing control signals TC1 through TCk are logic high, the first plurality of scan signal output units 1231D1 through 1231Dk may operate the first half of the scan electrodes Y1 through Yn of FIG. 2 by outputting a voltage received from the second power supply voltage control unit 1222, and when the timing control signals are logic low, the first plurality of scan signal output units 1231D1 through 1231Dk may operate the first half of the scan electrodes Y1 through Yn of FIG. 2 by outputting a voltage received from the first power supply voltage control unit 1221.

The second plurality of scan signal output units 1231Dk+1 through 1231Dn may operate in response to the timing control signals TCk+1 through TCn. For example, when the timing control signals TCk+1 through TCn are logic high, the second plurality of scan signal output units 1231Dk+1 through 1231Dn may operate the second half of the scan electrodes Y1 through Yn of FIG. 2 by outputting a voltage received form the second power supply voltage control unit 1222, and when the timing control signals TCk+1 through TCn are logic low, the second plurality of scan signal output units 1231Dk+1 through 1231Dn may operate the second half of the scan electrodes Y1 through Yn of FIG. 2 by outputting a voltage received from the first power supply voltage control unit 1221.

The scan signal output units 1231D1 through 1231Dn may be formed of a plurality of integrated circuit devices or a plurality of tape carrier packages.

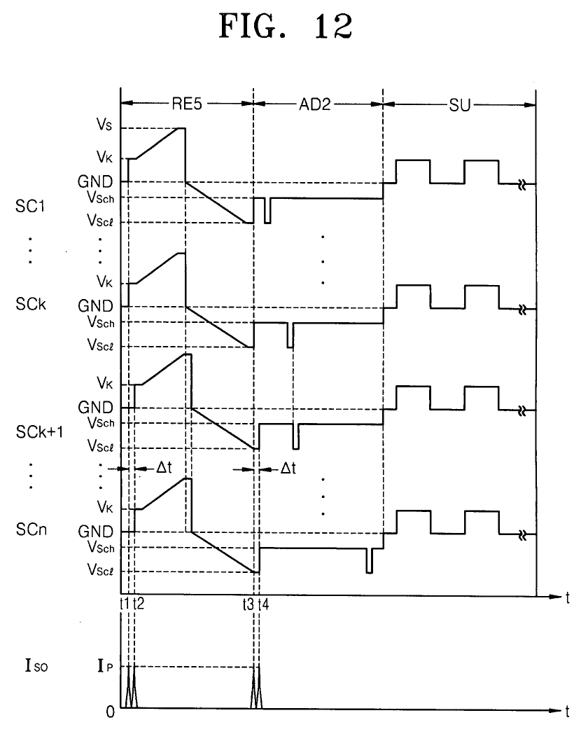

FIG. 11 illustrates a circuit diagram of the first and second power supply voltage control units 1221 and 1222 of FIG. 10, and one from among the plurality output units 1231D1 through 1231Dn connected to the first and second power supply voltage control units 1221 and 1222.

Referring to FIG. 11, the first power supply voltage control unit 1221 may include two PMOS transistors 1311 and 1312, and one NMOS transistor 1321. The first power supply voltage control unit 1221 may output and transmit any one of voltages from among a plurality of power supply voltages Vs and Vk, received from outside and an internal ground voltage GND, to the scan signal output unit 1231D1, in response to voltage control signals PS1a through PS1c, received from the timing control unit 1211 of FIG. 10.

The first PMOS transistor 1311 is activated when the voltage control signal PS1a is logic low, and outputs the power supply voltage Vk as an output voltage of the first power supply voltage control unit 1221, but when the voltage control signal PS1a is logic high, the first PMOS transistor 1311 is deactivated, and does not output the power supply voltage Vk. The second PMOS transistor 1312 is activated when the voltage control signal is PS1b is logic low, and outputs the power supply voltage Vs as an output voltage of the first power supply voltage control unit 1221, but when the voltage control signal PS1b is logic high, the second PMOS transistor 1312 is deactivated and does not output the power supply voltage Vs. The NMOS transistor 1321 is activated when the voltage control signal PS1c is logic high, and outputs the ground voltage GND as an output voltage of the first power supply voltage control unit 1221, but when the voltage control signal PS1c is logic low, the NMOS transistor 1321 is deactivated and does not output the ground voltage GND.

Referring to FIG. 11, the second power supply voltage control unit 1222 may include a plurality of NMOS transistors 1351 and 1352. The second power supply voltage control unit 1222 may output and transmit any one of the plurality of power supply voltages Vsch and Vscl, received externally, to the scan signal output unit 1231D1, in response to voltage control signals PS2a and PS2b received from the timing control unit 1211 of FIG. 10. When the voltage control signal PS2a is logic high, the first NMOS transistor 1351 is activated and outputs the power supply voltage Vsch as an output voltage of the second power supply voltage control unit 1222, and when the voltage control signal PS2a is logic low, the first NMOS transistor 1351 is deactivated and does not output the power supply voltage Vsch. When the voltage control signal PS2b is logic high, the second NMOS transistor 1352 is activated and outputs the power supply voltage Vscl as an output voltage of the second power supply voltage control unit 1222, and when the voltage control signal PS2b is logic low, the second NMOS transistor 1352 is deactivated and does not output the power supply voltage Vscl. The NMOS transistors 1351 and 1352 may be formed of PMOS transistors.

Referring to FIG. 11, the scan signal output unit 1231D1 may include a PMOS transistor 1331 and an NMOS transistor 1341. A timing control signal TC1 may be applied to gates of the PMOS transistor 1331 and the NMOS transistor 1341. Accordingly, when the timing control signal TC1 is logic low, the PMOS transistor 1331 is activated, and thereby the scan signal output unit 1341D1 outputs a power supply voltage, received from the first power supply voltage control unit 1221, as a scan signal SC1. When the timing control signal TC1 is logic high, the NMOS transistor 1341 is activated, and thereby the scan signal output unit 1231D1 outputs a power supply voltage, received from the second power supply voltage control unit 1222, as the scan signal SC1.

FIG. 12 illustrates a timing diagram of the scan signals SC1 through SCn of FIG. 10, and peak values Ip of a current Iso flowing through an output terminal of the scan electrode driving unit 331 illustrated in FIG. 1.

In order to display an image on the PDP 351 of FIG. 1, the plurality of scan signals SC1 through SCn, output from the scan electrode driving unit 331 of FIG. 1, may be applied to the plurality of scan electrodes Y1 through Yn of FIG. 2. At this time, the plurality of scan signals SC1 through SCn may be classified into two groups of scan signals SC1 through SCk and SCk+1 through SCn. That is, the plurality of scan signals SC1 through SCn may be classified into a first plurality of scan signals SC1 through SCk and a second plurality of scan signals SCk+1 through SCn. The plurality of scan signals SC1 through SCn controls gray scale of an image by performing a reset period RE5, an address period AD2, and the sustain period SU.

In the reset period RE5, first, the first plurality of scan signals SC1 through SCk may be simultaneously applied to a first half of the scan electrodes Y1 through Yn of FIG. 2, and, after a predetermined time interval Δt, the second plurality of scan signals SCk+1 through SCn may be simultaneously applied to a second half of the scan electrodes Y1 through Yn of FIG. 2. In the reset period RE5, the scan signals SC1 through SCn may each include a positive pulse and a negative pulse. The positive pulses may rapidly increase from a first voltage GND to a second voltage Vk, and then slowly increase to the maximum voltage Vs, whereas the negative pulses may slowly decrease from a ground voltage GND to a third voltage Vscl and then rapidly increase from the third voltage Vscl to a fourth voltage Vsch. The positive pulses may rapidly increase from the first voltage GND to the second voltage Vk and then slowly increase to the maximum voltage Vs. The negative pulses may slowly decrease from the ground voltage GND to the third voltage Vscl and then rapidly increase form the third voltage Vscl to the fourth voltage Vsch. Here, the first voltage GND may be the ground voltage and the second voltage Vk is a positive voltage higher than the ground voltage. The third voltage Vscl may be a negative voltage lower than the ground voltage GND and the fourth voltage Vsch may be a negative voltage lower than the ground voltage GND and higher than the third voltage Vscl.

In the address period AD2, scan pulses of the plurality of scan signals SC1 through SCn may be sequentially applied to the scan electrodes Y1 through Yn of FIG. 2.

In the sustain period SU, sustain pulses of the plurality of scan signals SC1 through SCn may be applied to the scan electrodes Y1 through Yn of FIG. 2.

As described above, in the reset period RE5, the first plurality of scan signals SC1 through SCk and the second plurality of scan signals SCk+1 through SCn may be applied to the scan electrodes Y1 through Yn at a respectively predetermined time interval. That is, at a first point of time t1 in the reset period RE5, the first plurality of scan signals SC1 through SCk rapidly increases from the first voltage GND to the second voltage Vk, and at a second point of time t2 after a predetermined time interval Δt, the second plurality of scan signals SCk+1 through SCn rapidly increases from the first voltage GND to the second voltage Vk. Also, at a third point of time t3 in the reset period RE, the first plurality of scan signals SC1 through SCk rapidly increases from the third voltage Vscl to the fourth voltage Vsch, and at a fourth point of time t4 after the predetermined time interval Δt, the second plurality of scan signals SCk+1 through SCn rapidly increases form the third voltage Vscl to the fourth voltage Vsch.

Accordingly, by classifying the scan signals SC1 through SCn into two groups and applying the classified scan signals SC1 through SCn to the scan electrodes Y1 through Yn of FIG. 4 at the first through fourth point of time t1 through t4 at the mutual predetermined time interval Δt in the reset period RE, the peak values Ip of the current Iso flowing through an output terminal of the scan electrode driving unit 331 of FIG. 3 at the first through fourth point of time 1t through t4 are half of the peak values Ip of FIG. 2 of the conventional current Iso of FIG. 2 in which the scan signals SC1 through SCn are simultaneously applied to the scan electrodes Y1 through Yn of FIG. 4 without being classified. Thus, an electro-magnetic interference inside the scan electrode driving unit 331 of FIG. 1 may be reduced or prevented.

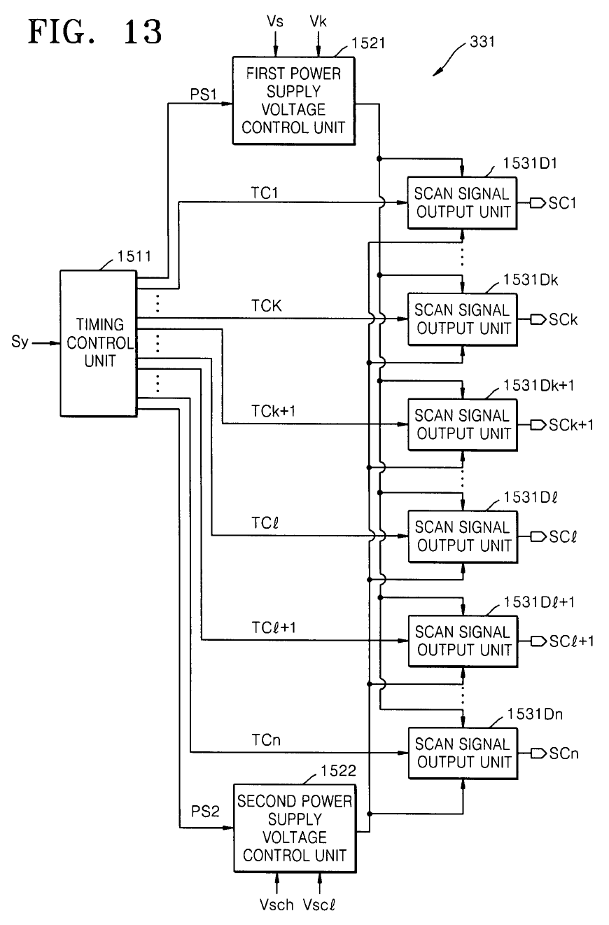

FIG. 13 illustrates a block diagram of the scan electrode driving unit 331 illustrated in FIG. 1 according to an embodiment of the present invention. Referring to FIG. 13, the scan electrode driving unit 331 may include a timing control unit 1511, first and second power supply voltage control units 1521 and 1522, and a plurality of scan signal output units 1531D1 through 1531Dn.

The timing control unit 1511 may be connected to the plurality of scan signal output units 1531D1 through 1531Dn. The timing control unit 1511 may receive a scan control signal Sy output from the control unit 311 of FIG. 1, and may output a plurality of voltage control signals PS1 and PS2 and a plurality of timing control signals TC1 through TCn. When the scan control signal Sy is applied, the timing control unit 1511 is activated in order to output the plurality of voltage control signals PS1 and PS2 and the plurality of timing control signals TC1 through TCn to the plurality of scan signal output units 1531D1 through 1531Dn.

The first power supply voltage control unit 1521 may be connected to the plurality of scan signal output units 1531D1 through 1531Dn. The first power supply voltage control unit 1521 receives a plurality of power supply voltages Vs and Vk, output from a power supply unit (not illustrated), and outputs and transmits one of the plurality of power supply voltages Vs and Vk to the plurality of scan signal output units 1531D1 through 1531Dn, in response to the voltage control signal PS1.

The second power supply voltage control unit 1522 may be connected to the plurality of scan signal output units 1531D1 through 1531Dn. The second power supply voltage control unit 1522 may receive a plurality of power supply voltages Vsch and Vscl, output from the power supply unit, and may output and transmit one of the plurality of power supply voltages Vsch and Vscl to the plurality of scan signal output units 1531D1 through 1531Dn, in response to the voltage control signal PS2.

The plurality of scan signal output units 1531D1 through 1531Dn may each be connected to a corresponding scan electrode of the plurality of scan electrodes Y1 through Yn of FIG. 2. The plurality of scan signal output units 1531D1 through 1531Dn may operate the scan electrodes Y1 through Yn of FIG. 2 by receiving any one of voltages Vs, Vk, Vsch, Vscl, and GND, transmitted from the first and second power supply voltage control units 1521 and 1522, in response to the timing control signals TC1 through TCn, output form the timing control unit 1511.

The plurality of scan signal output units 1531D1 through 1531Dn may be classified into three groups. That is, the plurality of scan signal output units 1531D1 through 1531Dn is classified into a first plurality of scan signal output units 1531D1 through 1531Dk, a second plurality of scan signal output units 1531Dk+1 through 1531Dl, and a third plurality of scan signal output units 1531Dl+1 through 1531Dn. The first plurality of scan signal output units 1531D1 through 1531Dk may be connected to a first third of the plurality of scan electrodes Y1 through Yn of FIG. 4, the second plurality of scan signal output units 1531Dk+1 through 1531Dl may be connected to a second third of the plurality of scan electrodes Y1 through Yn of FIG. 4, and the third plurality of scan signal output units 1531Dl+1 through 1531Dn may be connected to a third third of the plurality of scan electrodes Y1 through Yn of FIG. 4.

The first plurality of scan signal output units 1531D1 through 1531Dk may operate in response to timing control signals TC1 through TCk. For example, when the timing control signals TC1 through TCk are logic high, the first plurality of scan signal output units 1531D1 through 1531Dk outputs a voltage, transmitted from the second power supply voltage control unit 1522 in order to operate the first ⅓ of the scan electrodes Y1 through Yn of FIG. 4. When the timing control signals TC1 through TCk are logic low, the first plurality of scan signal output units 1531D1 through 1531Dk outputs a voltage, transmitted from the first power supply voltage control unit 1521 in order to operate the first ⅓ of the scan electrodes Y1 through Yn of FIG. 4

The second plurality of scan signal output units 1531Dk+1 through 1531Dl may operate in response to timing control signals TCk+1 through TCl. For example, when the timing control signals TCk+1 through TCl are logic high, the second plurality of scan signal output units 1531Dk+1 through 1531Dl outputs a voltage, transmitted from the second power supply voltage control unit 1522 in order to operate the second ⅓ of the scan electrodes Y1 through Yn of FIG. 2. When the timing control signals TCk+1 through TCl are logic low, the second plurality of scan signal output units 1531Dk+1 through 1531Dl outputs a voltage, transmitted from the first power supply voltage control unit 1521 in order to operate the second ⅓ of the scan electrodes Y1 through Yn of FIG. 2.

The third plurality of scan signal output units 1531Dl+1 through 1531Dn operates in response to timing control signals TCl+1 through TCn. For example, when the timing control signals TCl+1 through TCn are logic high, the third plurality of scan signal output units 1531Dl+1 through 1531Dn outputs a voltage, transmitted from the second power supply voltage control unit 1522 in order to operate the third ⅓ of the scan electrodes Y1 through Yn of FIG. 4. When the timing control signals TCl+1 through TCn are logic low, the third plurality of scan signal output units 1531Dl+1 through 1531Dn outputs a voltage, transmitted from the first power supply voltage control unit 1521 in order to operate the third ⅓ of the scan electrodes Y1 through Yn of FIG. 4.

The scan signal output units 1531D1 through 1531Dn may be a plurality of integrated circuit devices or a plurality of tape carrier packages.

Internal circuits and operations of the first and second power supply voltage control units 1521 and 1522 and the second signal output units 1531D1 through 1531Dn may be the same to the internal circuits and operations of the first and second power supply voltage control units 1521 and 1522 and the scan signal output unit 1531D1 of FIG. 3, and accordingly, detailed descriptions thereof is omitted herein.

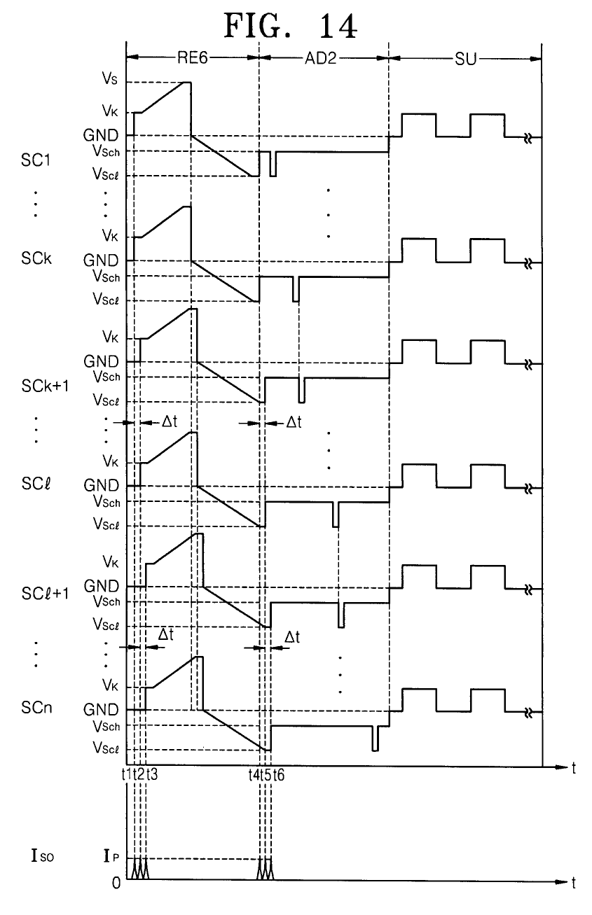

FIG. 14 illustrates a timing diagram of the scan signals SC1 through SCn illustrated in FIG. 1 and size of a current Iso flowing through an output terminal of the scan electrode driving unit 331 illustrated in FIG. 1.

In order to display an image on the PDP 351 of FIG. 1, the plurality of scan signals SC1 through SCn, output from the scan electrode driving unit 331 of FIG. 1 may be applied to the plurality of scan electrodes Y1 through Yn of FIG. 2. At this time, the plurality of scan signals SC1 through SCn may be classified into a first plurality of scan signals SC1 through SCk, a second plurality of scan signals SCk+1 through SCl and a third plurality of scan signals SCl+1 through SCn. The first through third plurality of scan signals SC1 through SCn controls gray scale of an image by performing a reset period RE6, the address period AD2, and the sustain period SU.

In the reset period RE6, the first plurality of scan signals SC1 through SCk may be simultaneously applied to a first ⅓ of the scan electrodes Y1 through Yn of FIG. 2, then after a predetermined time interval Δt, the second plurality of scan signals SCk+1 through SCl are applied to a second ⅓ of the scan electrodes Y1 through Yn of FIG. 4, and then after the predetermined time interval Δt, the third plurality of scan signals SCl+1 through SCn are applied to a third ⅓ of the scan electrodes Y1 through Yn. During the reset period RE6, the scan signals SC1 through SCn each includes a positive pulse and a negative pulse. The positive pulses may rapidly increase from a first voltage GND to a second voltage Vk and then slowly increase to the maximum voltage Vs, whereas the negative pulses may slowly decrease from a ground voltage GND to a third voltage Vscl and then rapidly increase from the third voltage Vscl to a fourth voltage Vsch. The first voltage GND may be a ground voltage and the second voltage Vk may be a positive voltage higher than the ground voltage. The third voltage Vscl may be a negative voltage lower than the ground voltage GND and the fourth voltage Vsch may be a negative voltage lower than the ground voltage GND and higher than the third voltage Vscl.

In the address period AD2, scan pulses of the plurality of scan signals SC1 through SCn may be sequentially applied to the scan electrodes Y1 through Yn of FIG. 2. In the sustain period SU, sustain pulses of the plurality of scan signals SC1 through SCn are alternatively applied to the scan electrodes Y1 through Yn of FIG. 2.

As described above, in the reset period RE6, the first plurality of scan signals SC1 through SCk, the second plurality of scan signals SCk+1 through SCl, and the third plurality of scan signals SCl+1 through SCn are applied to the scan electrodes Y1 through Yn at the predetermined time interval Δt. That is, at a first point of time t1 in the reset period RE6, the first plurality of scan signals SC1 through SCk rapidly increases from the first voltage GND to the second voltage Vk, at a second point of time t2 after the predetermined time interval Δt, the second plurality of scan signals SCk+1 through SCl rapidly increases from the first voltage GND to the second voltage Vk, and at a third point of time t3 after the predetermined time interval Δt, the third plurality of scan signals SCl+1 through SCn may rapidly increase from the first voltage GND to the second voltage Vk. Also, at a fourth point of time t4 of the reset period RE, the first plurality of scan signals SC1 through SCk may rapidly increase from the third voltage Vscl to the fourth voltage Vsch, at a fifth point of time t5 after the predetermined time interval Δt, the second plurality of scan signals SCk+1 through SCl may rapidly increases from the third voltage Vscl to the fourth voltage Vsch, and at a sixth point of time t6 after the predetermined time interval Δt, the third plurality of scan signals SCl+1 through SCn may rapidly increases from the third voltage Vscl to the fourth voltage Vsch.

As described above, by classifying the scan signals SC1 through SCn into three groups and applying the classified scan signals SC1 through SCn to the scan electrodes Y1 through Yn of FIG. 2 at the first through sixth points of time t1 through t6 at the mutual predetermined time interval Δt in the reset period RE6, peak values Ip of the current Iso flowing through the output terminal of the scan electrode driving unit 331 of FIG. 1 at the first through sixth points of time t1 through t6 may be reduced to ⅓ of the peak value of the conventional driving method in which the scan signals are simultaneously applied to the scan electrodes Y1 through Yn of FIG. 2. Accordingly, an electro-magnetic interference inside the scan electrode driving unit 331 of FIG. 1 may be reduced or prevented.

As described in connection with FIGS. 13 and 14, as the number of the scan electrodes Y1 through Yn of FIG. 2 included in the PDP 351 of FIG. 1 increases, the number of groups the scan electrodes Y1 through Yn of FIG. 2 are classified into may increase.

According to embodiments, by classifying address signals AS1 through ASm into a plurality of groups and increasing or decreasing the voltage of groups of the classified address signals AS1 through ASm such that the voltage change of the groups are separated from each other by at a predetermined time interval Δt, or by floating the classified address signals AS1 through ASm, when scan signals SC1 through SCn rapidly increase from a ground voltage GND to a voltage Vk, higher than the ground voltage GND, in a reset period RE, a peak value Ip of a current Iao flowing through an output terminal of an address electrode driving unit 321 decreases. Accordingly, an electro-magnetic interference in an internal circuit of an address electrode driving unit 321 may be reduced or prevented. Thus, the address electrode driving unit 321 may operate normally, without any malfunction.

Also, according to embodiments, by classifying scan electrodes Y1 through Yn and scan signals SC1 through SCn into a plurality of groups and increasing or decreasing the voltage of groups of the classified scan signals SC1 through SCn such that the voltage change of the groups are separated from each other by a predetermined time interval in a reset period, peak values Ip of a current Iso flowing through an output terminal of a scan electrode driving unit 331 during the initial and final portion of the reset period decrease. Accordingly, as the peak values Ip of the current Iso flowing through the output terminal of the scan electrode driving unit 331 decreases in the reset period, an electro-magnetic interference in internal circuit of the scan electrode driving unit 331 may be reduced or prevented. Thus, the scan electrode driving unit 331 operates normally without any malfunction.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving electrodes in a plasma display device, which includes a plurality of first electrodes and a plurality of second electrodes for performing a reset and a display period, the method comprising:
classifying a plurality of first drive signals, applied to the plurality of first electrodes, into a plurality of groups; and
increasing the voltage of the plurality of groups of first drive signals from a first voltage to a second voltage during the reset period, the increase of the voltage of the plurality of groups of first electrodes having a predetermined time interval therebetween.

2. The method as claimed in claim 1, further comprising, simultaneous with the increasing the voltage of the plurality of groups of first drive signals, increasing the voltage of a second drive signal, applied to the plurality of second electrodes, from a ground voltage to a positive voltage higher than the ground voltage.

3. The method as claimed in claim 2, wherein the voltage of the second drive signal rapidly increases from the ground voltage to the positive voltage, and during this time, the voltage of groups of the first drive signals is increased while having a predetermined time interval between the voltage increases of the groups.

4. The method as claimed in claim 3, wherein the voltage of the second drive signal is rapidly increased from the ground voltage to the positive voltage, and then slowly increased from the positive voltage to a higher positive voltage during the reset period.

5. The method as claimed in claim 2, wherein the first voltage is a ground voltage.

6. The method as claimed in claim 2, wherein the second voltage is a positive voltage.

7. The method as claimed in claim 2, wherein the voltage of the second drive signal is decreased from the positive voltage to a negative voltage lower than the ground voltage during the reset period.

8. The method as claimed in claim 1, further comprising, during the reset period, applying a negative pulse decreasing from a ground voltage to a third voltage and increasing from the third voltage to a fourth voltage, to the first electrodes.

9. The method as claimed in claim 8, wherein a positive pulse applied to the first electrodes rapidly increases from the ground voltage to the first voltage.

10. The method as claimed in claim 8, wherein the first voltage is the ground voltage.

11. The method as claimed in claim 8, wherein the second voltage is a positive voltage.

12. The method as claimed in claim 8, wherein the third voltage is a negative voltage lower than the ground voltage.

13. The method as claimed in claim 8, wherein the fourth voltage is a negative voltage lower than a ground voltage and higher than the third voltage.

14. The method as claimed in claim 8, wherein scan pulses are sequentially applied to the first electrodes during the display period.

15. The method as claimed in claim 1, wherein the first electrodes are address electrodes and the second electrodes are scan electrodes.

16. The method as claimed in claim 1, wherein the first electrodes are scan electrodes and the second electrodes are address electrodes.

17. A method of driving electrodes in a plasma display device, which includes a plurality of scan electrodes and a plurality of address electrodes for performing a reset period and a display period; the method comprising:
increasing a voltage of a scan signal applied to the plurality of scan electrodes from a ground voltage to a positive voltage higher than the ground voltage; and
simultaneously floating a plurality of address signals applied to the plurality of address electrodes for a predetermined time during the reset period.

18. The method as claimed in claim 17, wherein the plurality of address signals are floated while the voltage of the scan signal increases from the ground voltage to the positive voltage.

19. The method as claimed in claim 17, wherein the voltage of the scan signal is rapidly increased from the ground voltage to the positive voltage and then slowly increased to a higher positive voltage during the reset period.

20. The method as claimed in claim 19, wherein the voltage of the scan signal is decreased from the positive voltage to a negative voltage lower than the ground voltage during the reset period.
